(19) United States
(12) Patent Application Publication
(10) Pub. No.: US 2010/0065404 A1
(43) Pub. Date: Mar. 18, 2010

(54) CURVED BELT

(75) Inventors: Yasuaki TANIGUCHI, Nara (JP); Yasunori ISHIKIRIYAMA, Nara (JP)

Correspondence Address: DITTHAVONG MORI & STEINER, P.C., 918 Prince Street, Alexandria, VA, 22314, US

(73) Assignee: NITTA CORPORATION, Osaka-shi ,Osaka (JP)

(21) Appl. No.: 12/441,713

(22) PCT Filed: Mar. 27, 2008
(86) PCT No.: PCT/JP2008/056649

§ 371 Date: Mar. 17, 2009

(30) Foreign Application Priority Data
Mar. 28, 2007 (JP) 2007-084145

(51) Int. Cl. B65G 15/30

(52) U.S. Cl. 198/844.1

(57) ABSTRACT

The inventive curved belt includes first electrically conductive members provided to belt fabric in a first direction and second electrically conductive members provided to the belt fabric in a second direction that intersects the first direction. Static electricity accumulated in the curved belt is eliminated throughout the curved belt by the first and second electrically conductive members.

### TECHNICAL FIELD

The present invention relates to a curved belt, which is used in a curved conveyor system.

### BACKGROUND ART

When the belt is driven, the back side of the belt successively comes into contact with and separates from a belt drive roller, and friction (including slippage) between the roller and the belt occurs. As a result, static electricity is collected on the belt.

When static electricity collects on the belt, a conveyance failure is more likely due to the adherence of dust or lightweight objects (such as paper) onto the belt. Furthermore, when the charge voltage is high, a spark may be released, and thus, electrical system failure or fire may occur. Therefore, a conveyor system provided with anti-static structure is proposed.

Conventionally, an anti-static method is known that prevents static electric charge from building up on a belt by applying an adhesive that contains a surfactant or carbon, which are conductive materials, onto the nonconductive belt fabric. However, this type of belt is not very durable. There also exists an anti-static belt having a conductive member (e.g., a fiber) arranged in the belt drive direction. For example, in the case of a linear conveyor, the method of using yarn including a conductive fiber partly woven into the belt fabric in the belt drive direction is known (refer to Patent Citation 1).

### DISCLOSURE OF INVENTION

### Technical Problem

However, as for a curved belt, the belt fabric is cut out of raw fabric as a partial annulus, and then formed as a truncated cone by connecting both ends. Therefore, the relationship between the direction of the fabric yarn and the belt drive direction varies. Thus, it is impossible to construct a belt in which the direction of the conductive member (fiber) coincides with the belt drive direction throughout the curved belt using the same structures applied to a linear belt. Consequently, the static charge can only be prevented at certain areas of a curved belt. Furthermore, in terms of manufacturing, it is not only quite difficult to arrange the conductive members along the arc of the curved belt to coincide with the direction of the belt drive direction, but it is also costly.

An object of the present invention is to provide a belt for a curved conveyor that has improved durability and anti-static performance with a simple structure and at low cost.

### Technical Solution

The inventive curved belt includes first electrically conductive members disposed in the belt fabric in a first direction and second electrically conductive members disposed in the belt fabric in a second direction that intersects the first direction. Static electricity accumulated on the curved belt is eliminated throughout the curved belt by the first and second electrically conductive members.

In a preferable example, the first direction and the second direction intersect orthogonally. Furthermore, the curved belt may include a layer of the belt fabric and a cover member layer. In such a case, the first and the second electrically conductive members may be warp and weft of the belt fabric and the first and second electrically conductive members are each disposed on the belt fabric at predetermined intervals. Furthermore, the curved belt is formed into the shape of a truncated cone.

### Advantageous Effects

According to the present invention, a belt for a curved conveyor is provided that is improved in durability and anti-static performance with simple structure and at low cost.

### [Patent Citation]

Japanese Unexamined Patent Publication No. H09-142687

### BRIEF DESCRIPTION OF DRAWINGS

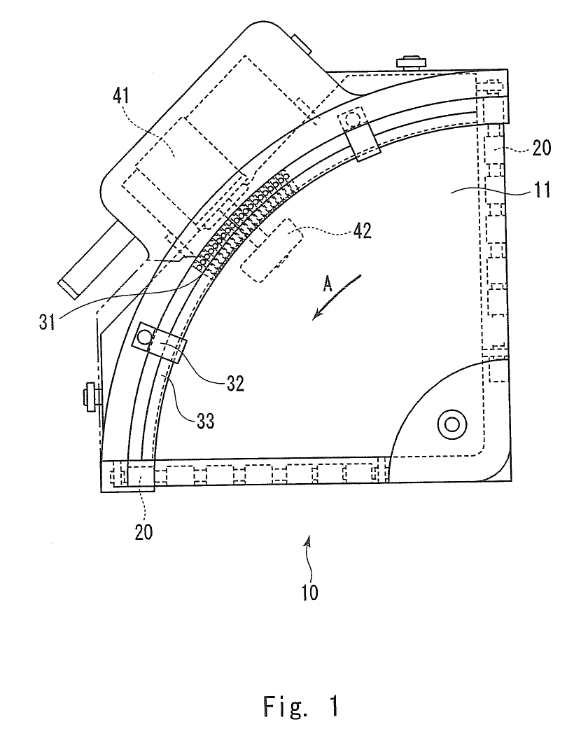

### [FIG. 1]

FIG. 1 is a plan view of a curved conveyor of the first embodiment of the present invention.

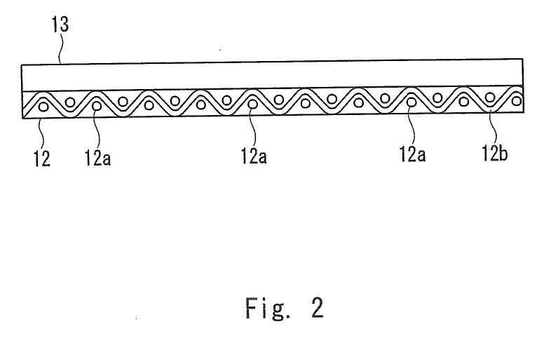

### [FIG. 2]

FIG. 2 is a sectional view of the curved belt illustrated in FIG. 1.

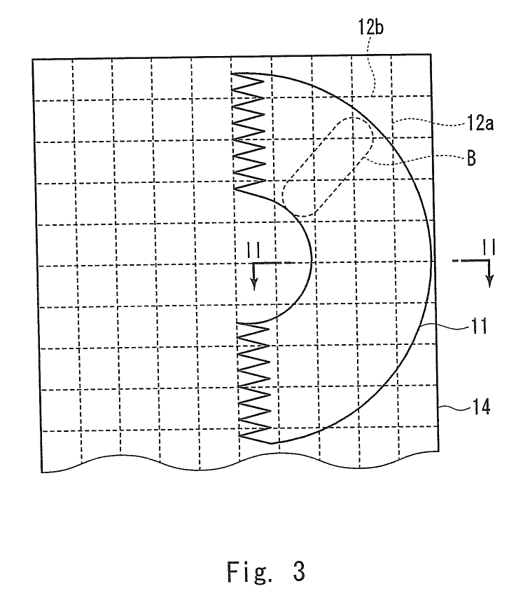

### [FIG. 3]

FIG. 3 is a plan view of the raw fabric from which the curved belt of FIG. 1 is cut out.

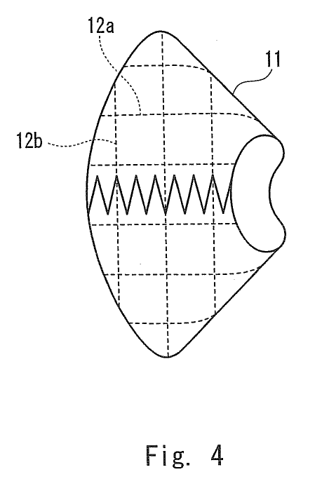

### [FIG. 4]

FIG. 4 is a schematical perspective view of the curved belt formed into a truncated cone by connecting both ends of the partial annulus depicted in FIG. 3.

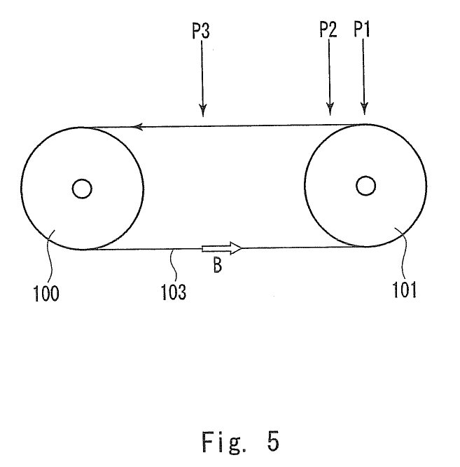

### [FIG. 5]

FIG. 5 schematically illustrates a device for testing the static electricity elimination of the belts in the comparative examples and the inventive examples.

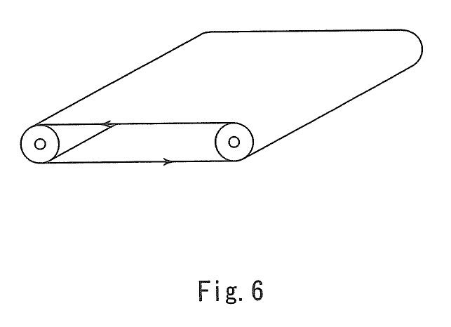

### [FIG. 6]

FIG. 6 schematically illustrates the structure of the belt used in comparative example 1.

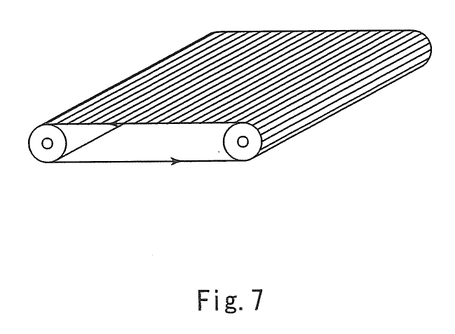

### [FIG. 7]

FIG. 7 schematically illustrates the structure of the belt used in comparative example 2.

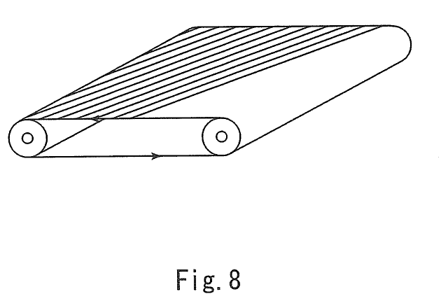

### [FIG. 8]

FIG. 8 schematically illustrates the structure of the belt used in comparative example 3.

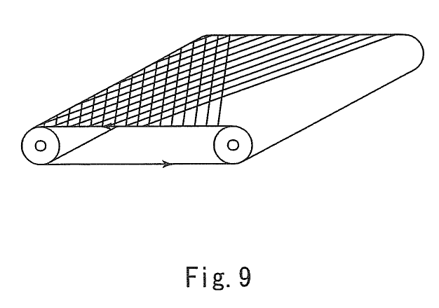

### [FIG. 9]

FIG. 9 schematically illustrates the structure of the belt used in inventive example 1

### EXPLANATION OF REFERENCES

10 Curved conveyor
11 Curved belt
12a, 12b Electrically conductive members
12 Fabric
13 Cover member

### BEST MODE FOR CARRYING OUT THE INVENTION

In the following, an embodiment of the present invention will be explained with reference to the drawings.

FIG. 1 is a plan view of a curved conveyor to which a curved belt of the embodiment regarding the present invention is applied. In the curved conveyor 10, the curved belt 11 is entrained about two end rollers 20, which are separated at a predetermined angle. Thus, the curved belt 11 is stretched between two end rollers 20 with the plan view having a partial annular profile.

The curved belt 11 is provided with beads 31 that are attached along its peripheral edge. Each of the beads has a protuberance that is engaged with a guide member 33 which is fixed to the conveyor body 10, so that the curved belt is prevented from slipping toward the center of the above-mentioned annulus by a centripetal force during operation.

The guide member 33 includes an arcuate rod and is fixed to the conveyor body 10 by support members 32. The guide member 33 is arranged along the periphery of the curved belt 11 such that the arcuate rod is engaged with the protuberances of the beads 31. The curved belt 11 is thereby driven without any centripetal deviation.

In the present embodiment, a structure having a series of the isolated beads 31, which is retained by the rod-type guide members, is explained as an example. However, a continuous bead provided along the peripheral edge of the curved belt may also be used. In such a case, the bead may be held by rollers so as to retain the periphery of the curved belt 11.

A drive component of the curved conveyor 10 includes a motor 41 and a drive roller 42. The drive roller 42 is connected to the motor 41 and the curved belt 11 is pinched between the drive roller 42 and a pinch roller. The curved belt 11, which is pinched between the drive roller 42 and the pinch roller, is driven when the motor 41 rotates the drive roller.

FIG. 2 is a sectional view of the curved belt 11. For example, the curved belt 11 includes fabric 12 and a cover member 13, such as polyurethane, and the cover member 13 is laminated over the fabric 12. As shown in FIG. 1, the curved belt 11 is entrained about the end rollers 20 so that the fabric 12 is arranged inside and the cover member 12 outside.

FIG. 3 is a plan view of raw fabric 14 from which the curved belt 11 is cut out. The raw fabric 14 is laminated by covering the fabric 12 with the cover member 13. For example, the fabric 12 is woven fabric of electrically nonconductive fiber, such as polyester fiber. However, warp 12a and weft 12b having electrical conductivity (electrically conductive fiber) are woven in at predetermined intervals.

FIG. 2 is a sectional view of the raw fabric 14 or the belt 11 along line II-II of FIG. 3 (the line in which the weft 12b coincides with the radial direction). Although FIG. 2 schematically illustrates the electrically conductive fiber or yarn 12b woven in among the electrically nonconductive fibers or yarns at every sixth fiber, actually, a large quantity of electrically conductive fiber is densely woven in as the warp and weft. As for the electrically conductive warp 12a and weft 12b may consist of, for example, metal fiber, carbon fiber, or the like, or a combination thereof, or a yarn in which the electrically nonconductive fiber is plied together with the aforementioned electrically conductive fiber.

As shown in FIG. 3, the curved belt 11 is cut out from the raw fabric 14 as a partial annulus having a predetermined arc size. In the present embodiment, the curved belt 11 is cut out as a partial annulus having an arc angle of approximately 180 degrees. Both ends of the cut-out partial annular-shaped curved belt 11 are connected and the curved belt 11 is thus formed into an endless belt shaped as a truncated cone, as shown in FIG. 4. When the curved belt 11, which is formed as a truncated cone, is entrained about the end rollers 20, it is stretched into a form having a partial annulus profile with arc angle of approximately 90 degrees, as shown in FIG. 1.

As illustrated in FIG. 1, the curved belt 11 is driven in direction A along the arc. If a curved belt without the electrically conductive fiber is applied and driven in this operation, static electricity, which is induced by repeated contact and separation with the rollers continuously occurring between the back side of the belt and the end roller 20 or the drive roller 24, and by friction (including slippage) between the belt 11 and the rollers 20 and 24, accumulates on the curved belt.

The build-up of static charge in the belt can generally be prevented by weaving in electrically conductive fiber in the belt drive direction. The efficiency of static electricity elimination is dependent on the orientation of the electrically conductive fiber with respect to the belt drive direction. When the electrically conductive fiber is aligned in the direction parallel to the belt drive direction, elimination of the static electricity is efficient. However, when the electrically conductive fiber is aligned in the direction perpendicular to the belt drive direction, static electricity is not effectively eliminated. Namely, the efficiency of the static electricity elimination is maximal when the belt drive direction and the electrically conductive fibers intersect at zero degrees (the parallel orientation), and gradually declines as the angle approaches 90 degrees (the perpendicular orientation), where efficiency is minimal.

As for a linear conveyor, the belt drive direction can be aligned with either the weft or warp of the fabric at all times. However, in the case of the curved belt 11 including the warp 12a and the weft 12b, the relationship between the belt drive direction and the direction of either the warp 12a or the weft 12b varies according to the location of the belt 11.

When examining the warp 12a or the weft 12b, the area where the electrically conductive fiber and the belt drive direction generally coincide is restricted to a certain area. For example, within an area of the curved belt 11 around the line II-II of FIG. 3, the direction of the warp 12a coincides with the belt drive direction (tangentially), thereby the warp 12a substantially contributes to the static electricity elimination, while the weft 12b, which is perpendicular to the belt drive direction, hardly does. On the other hand, within an area around the connected ends of the curved belt 11, the direction of the weft 12b coincides with the belt drive direction (tangentially), thus substantially contributing to the static electricity elimination, while the warp 12a hardly contributes to the static electricity elimination since it is perpendicular to the belt drive direction.

In the present embodiment, the electrically conductive fiber is applied to both the warp 12a and the weft 12b, whereby sufficient efficiency in the static electricity elimination is obtained anywhere in the curved belt 11. Namely, in the curved belt 11 of the present embodiment, either the warp 12a or the weft 12b intersects the belt drive direction at an angle within 45 degrees at any position of the curved belt 11. Inside area B of FIG. 3, both the warp 12a and the weft 12b intersect the belt drive direction (tangentially) at approximately 45 degrees. Therefore, despite the fact that the efficiency of the static electricity elimination due to either the warp 12a or the weft 12b is reduced by approximately one half compared to that of the electrically conductive fiber aligned in the belt drive direction, the total efficiency is substantially the same as the efficiency obtained by the warp 12a, aligned in the belt drive direction, in the area around line II-II.

Note that when the angle of the warp 12a with respect to the belt drive direction increases, the angle of the weft 12b inversely decreases. Therefore, the total efficiency of the static electricity elimination is kept uniform at all places on the curved belt 11.

As described above, according to the curved belt of the present embodiment, the static electricity generated by the belt operation can be effectively eliminated at any position of the curved belt. Note that the curved belt of the present embodiment may also be a spiral conveyor belt.

Although in the present embodiment, the electrically conductive fiber or yarn is woven in at every sixth fiber position, the frequency of the electrically conductive warp and weft to be woven into the fabric is optional and not restricted in the present embodiment.

Furthermore, the electrically conductive member (fiber or yarn) is only required to be arranged in two directions, and not restricted to the warp and the weft. Namely, the electrically conductive fiber or yarn can be sewn into the belt fabric.

The directions in which the electrically conductive members are arranged are not required to be perpendicular, but only to be independent of each other. Furthermore, three or more groups of electrically conductive members, in which electrically conductive members in each group have the same orientation, can also be provided.

In the present embodiment, the description was based on a belt of a one-ply type, which is configured as a two-layer structure including one fabric layer and one cover member layer. However, the structure of the belt is not restricted to this type and it could be applied to structures having a plurality of layers. For example, it could be applied to a two-ply type having a four-layer structure including two fabric layers and two cover layers, which are laminated alternately. In such a case, it is sufficient if the electrically conductive member is provided on either the interposed fabric between the two cover member layers or the back face fabric. Furthermore, a combination of the fabric layers and the cover member layers optionally can be selected.

### Examples

Next, the effect of the present embodiment will be explained with reference to comparative examples and inventive examples. The experiment examined the static electricity elimination effect of the comparative examples and the inventive examples, in which the fabric including the electrically conductive members (fibers) woven in two directions was applied. Note that in this experimentation, a linear belt was used instead of a curved belt and polyester fabric was adopted as the fabric layer and PVC resin was adopted as the cover member.

FIG. 5 is a schematic diagram of the testing device used in the static electricity elimination test for the comparative examples and the inventive examples. As shown in FIG. 5, in the testing device, the linear belt 103 is entrained about a drive pulley 100 and a driven pulley 101 is driven in the direction indicated by the arrow B. Levels of static electrical charge were measured at three points P1, P2, and P3, respectively.

At first, the result for the comparative example 1 will be explained. As for the comparative example 1, a two-ply linear belt, into which no electrically conductive member (fiber) is woven, was used, as schematically illustrated in FIG. 6. The results of the measurement for two-ply linear belts, sample 1 and sample 2, of the comparative example 1 are listed in Table 1. As listed in Table 1, when the electrically conductive member is not used, static electrical charges of −0.10, −0.15, and −0.20 (kV) were detected for points P1-P3, respectively, for both samples 1 and 2.

TABLE 1
Comparative Example 1

| | P1 | P2 | P3 |
|---|---|---|---|
| Sample 1 | −0.10 kV | −0.15 kV | −0.20 kV |
| Sample 2 | −0.10 kV | −0.15 kV | −0.20 kV |

Next, the result for the comparative example 2 will be explained. In the comparative example 2, as schematically illustrated in FIG. 7, a two-ply linear belt, in which the electrically conductive members (fibers) are arranged in the belt lateral direction (the direction perpendicular to the belt drive direction), was used. Note that the electrically conductive members were only woven into the outer fabric. The results of the measurement for two samples (samples 1 and 2) of the comparative example 2 are listed in Table 2. As shown in Table 2, when the electrically conductive members was arranged in the belt lateral direction, which is perpendicular to the belt drive direction, the static electrical charge was eliminated at point P1, but static electrical charges of −0.10 and −0.20 (kV) were detected at points P2 and P3, respectively. Namely, the effect of the static electricity elimination is limited and hardly obtained at the position distant from the pulley.

TABLE 2
Comparative Example 2

| | P1 | P2 | P3 |
|---|---|---|---|
| Sample 1 | 0.00 kV | −0.10 kV | −0.20 kV |
| Sample 2 | 0.00 kV | −0.10 kV | −0.20 kV |

Next, the result for the comparative example 3 will be explained. In the comparative example 3, as schematically illustrated in FIG. 8, a one-ply linear belt, in which the electrically conductive members (fibers) are arranged in the fabric in a direction that intersects the belt drive direction at 45 degrees, was used. The test was also carried out for two samples (sample 1 and 2). As shown in Table 3, static electrical charge was also not detected at point P1 in both samples 1 and 2, but static electrical charges of −0.10 and −0.20 (kV) were detected at respective points P2 and P3 of sample 1, and static electrical charges of −0.05 and −0.15 (kv) were detected at respective points P2 and P3 of sample 2. Namely, static electricity elimination at points P2 and P3 was not sufficient.

TABLE 3
Comparative Example 3

| | P1 | P2 | P3 |
|---|---|---|---|
| Sample 1 | 0.00 kV | −0.10 kV | −0.20 kV |
| Sample 2 | 0.00 kV | −0.05 kV | −0.15 kV |

Next, the result for the inventive example 1 will be explained. As for the inventive example 1, a one-ply linear belt was used. As schematically illustrated in FIG. 9, fabric with the electrically conductive members (fibers) woven in two orthogonal directions was used. Furthermore, the electrically conductive members arranged in the two directions were disposed so that each member intersected the belt drive direction at 45 degrees. As listed in Table 4, static electrical charge was not detected at any of points P1-P3 in both samples 1 and 2. Thus, the static electricity was effectively eliminated.

TABLE 4
Inventive Example 1 (Inventive Examples 2 and 3)

| | P1 | P2 | P3 |
|---|---|---|---|
| Sample 1 | 0.00 kV | 0.00 kV | 0.00 kV |
| Sample 2 | 0.00 kV | 0.00 kV | 0.00 kV |

Furthermore, the same test was carried out in the system shown in FIG. 9 for the inventive examples 2 and 3 of two-ply linear belts. In this test, the same results as listed in Table 4 were obtained, thus demonstrating the effective removal of static electricity. Note that as for the belts used in the inventive example 2, both of the fabric layers had electrically conductive members (fibers) woven in two directions. As for the belts used in the inventive example 3, only the outer fabric layer was provided with the electrically conductive members (fibers), woven in two directions.

Accordingly, as clearly indicated by contrast between the inventive examples 1-3 and the comparative examples 1-3, the effect and efficiency of the static electricity elimination is substantially improved by the combination of the electrically conductive members arranged in two separate directions, which are dissimilar to the belt drive direction.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2007-084145 (filed on Mar. 28, 2007), which is expressly incorporated herein, by reference, in its entirety.

1. A curved belt comprising:
first electrically conductive members provided to belt fabric in a first direction; and
second electrically conductive members provided to the belt fabric in a second direction that intersects with the first direction;
wherein static electricity accumulated in the curved belt is eliminated throughout the curved belt by the first and the second electrically conductive members.

2. The curved belt as in claim 1, wherein the first direction and the second direction intersect orthogonally.

3. The curved belt as in claim 1, comprising a layer of the belt fabric and a cover member layer.

4. The curved belt as in claim 3, wherein the first and the second electrically conductive members comprise warp and weft of the belt fabric.

5. The curved belt as in claim 4, wherein the curved belt has the form of a truncated cone.

6. The curved belt as in claim 4, wherein the first electrically conductive members and the second electrically conductive members are each disposed in the belt fabric at predetermined intervals.
